(19) United States
(12) Patent Application Publication
(10) Pub. No.: US 2024/0127038 A1
(43) Pub. Date: Apr. 18, 2024

(54) VISUALIZATION OF AI METHODS AND DATA EXPLORATION

(71) Applicant: VIRGINIA TECH INTELLECTUAL PROPERTIES, INC., Blacksburg, VA (US)

(72) Inventors: RAN JIN, Blacksburg, VA (US); Xiaoyu Chen, Louisville, KY (US); Seyedeh Parshin Shojaee, Blacksburg, VA (US)

(21) Appl. No.: 18/478,331

(22) Filed: Sep. 29, 2023

Related U.S. Application Data
(60) Provisional application No. 63/377,609, filed on Sep. 29, 2022.

(51) Int. Cl. G06N 3/0455; G06N 3/08

(52) U.S. Cl. CPC G06N 3/0455; G06N 3/08

(57) ABSTRACT

Computation pipeline-dataset exploration, visualization, and recommendation concepts are described. For example, a method can include learning first visualization latent-space features of different datasets represented in a first two-dimensional latent space and second visualization latent-space features of different computation pipelines represented in a second two-dimensional latent space. The method can also include modeling dataset-pipeline interactions between the different datasets and the different computation pipelines based on the first visualization latent-space features and the second visualization latent-space features. The method can also include learning relationships between the first visualization latent-space features and the second visualization latent-space features based on modeling the dataset-pipeline interactions. In another example, the method can further include generating a visual representation of the relationships and the dataset-pipeline interactions. The visual representation can include latitude and longitude data indicative of the relationships and altitude data indicative of the dataset-pipeline interactions.

### CROSS-REFERENCE TO RELATED APPLICATION

This application claims the benefit of and priority to U.S. Provisional Patent Application No. 63/377,609, titled “VISUALIZATION OF AI METHODS AND DATA EXPLORATION,” filed Sep. 29, 2022, the entire contents of which is hereby incorporated by reference herein.

### BACKGROUND

Artificial Intelligence (AI) plays an important role in data-driven decision-making tasks related to complex problems such as complex engineering and healthcare problems. In recent years, various AI methods have been created in data-rich environments. However, due to the finite support and inductive bias of these methods, it is challenging to develop a one-size-fits-all AI method that can be used for any application. Instead, for each specific dataset, current practice requires an expert to manually search for an appropriate AI method that can achieve a certain satisfactory performance.

To determine which AI method should be implemented for a particular task, data scientists configure and evaluate different computation pipelines that each include a certain sequence of AI method configuration options. For example, the computation pipelines can each include a different sequence of AI method options for data sourcing, feature extraction, dimension reduction, tuning criteria, and model estimation. Data scientists also configure and evaluate different computation pipelines to determine which AI method should be implemented for a particular context in connection with, for instance, a certain domain, entity, task, or dataset. For example, data scientists can configure and evaluate different computation pipelines for different sample sizes, data distributions, data analytics objectives, requirements on performance and runtime metrics, custom designs, personalized specifications, and process settings.

Computation pipeline and dataset exploration systems, such as recommender-based systems, provide at least some degree of automation in connection with configuring and evaluating different computation pipelines with respect to different contexts to determine which sequence of AI method configuration options (i.e., which AI method) should be implemented for a particular task. Some of these systems further provide visualizations throughout the process to describe and guide the computation pipeline and dataset exploration. Generating visualizations that are both informative and perceivable by humans is challenging, in part because in the current-state of computation pipeline and dataset exploration, the datasets and the AI methods are isolated, in analog to isolated communities in the world prior to the Age of Discovery.

### SUMMARY

The present disclosure is directed to systems and methods for visualizing AI computation pipeline and dataset exploration. In particular, described herein is a latent neural recommender (LNR) system that can combine recommendation and variational latent-space generation methods to effectively learn interactive clustering patterns of different datasets and different computation pipelines in a low-dimensional latent-space. The LNR system can further predict dataset-pipeline interactions between the different computation pipelines and the different datasets (e.g., performance of the different computation pipelines with respect to the different datasets). The LNR system can also generate a visual representation of the interactive clustering patterns and the predicted dataset-pipeline interactions. In one example, the LNR system can generate a two-dimensional (2D) or three-dimensional (3D) visual representation (e.g., a grid or a sphere, respectively) having latitude and longitude data corresponding to the interactive clustering patterns and altitude data corresponding to the predicted dataset-pipeline interactions. An advantage of such a 2D or 3D visual representation is that it can visualize the distance and similarity among different datasets and different computation pipelines, similar to how a world map visualizes the distance and similarity of landscapes.

Aspects and advantages of embodiments of the present disclosure will be set forth in part in the following description or can be learned from the description or through practice of the embodiments. Other aspects and advantages of embodiments of the present disclosure will become better understood with reference to the appended claims and the accompanying drawings, all of which are incorporated in and constitute a part of this specification. The drawings illustrate example embodiments of the present disclosure and, together with the description, serve to explain the related concepts of the present disclosure.

According to one example embodiment, a method can include learning first visualization latent-space features of different datasets represented in a first two-dimensional latent space and second visualization latent-space features of different computation pipelines represented in a second two-dimensional latent space. The method can also include modeling dataset-pipeline interactions between the different datasets and the different computation pipelines based on the first visualization latent-space features and the second visualization latent-space features. The method can also include learning relationships between the first visualization latent-space features and the second visualization latent-space features based on modeling the dataset-pipeline interactions. In another example, the method can further include generating a visual representation of the relationships and the dataset-pipeline interactions. The visual representation can include latitude and longitude data indicative of the relationships and altitude data indicative of the dataset-pipeline interactions.

### BRIEF DESCRIPTION OF THE DRAWINGS

Many aspects of the present disclosure can be better understood with reference to the following figures. The components in the figures are not necessarily to scale, with emphasis instead being placed upon clearly illustrating the principles of the disclosure. Moreover, repeated use of reference characters or numerals in the figures is intended to represent the same or analogous features, elements, or operations across different figures. Repeated description of such repeated reference characters or numerals is omitted for brevity.

FIG. 1 illustrates a block diagram of an example environment that can facilitate visualization of computation pipeline and dataset exploration according to at least one embodiment of the present disclosure.

FIG. 2 illustrates a block diagram of an example latent neural recommender (LNR) system that can facilitate visualization of computation pipeline and dataset exploration according to at least one embodiment of the present disclosure.

FIG. 3A illustrates an example visual representation of learned computation pipeline-dataset relationships and predicted pipeline-dataset interactions according to at least one embodiment of the present disclosure.

FIG. 3B illustrates another example visual representation of learned computation pipeline-dataset relationships and predicted pipeline-dataset interactions according to at least one embodiment of the present disclosure.

FIG. 4 illustrates a flow diagram of an example computer-implemented method that can facilitate visualization of computation pipeline and dataset exploration according to at least one embodiment of the present disclosure.

### DETAILED DESCRIPTION

Around six hundred years ago when humans started to travel around the world and discover different landscapes, they gradually created a visualization of the world called “world map.” Nowadays, humans are opening the doors to the world of artificial intelligence (AI). Various machine learning (ML) models have been developed to augment existing automation and human-centric systems by providing superior prediction performance. However, due to the finite support and inductive bias of existing models, developing a one-size-fits-all model that can be used for any application has been a challenge.

For each specific dataset, current practice requires an expert in data science to manually search for an appropriate ML technique that can achieve a certain satisfactory performance. As described further below, even the state-of-the-art automatic machine learning (AutoML) methods need to explore a large model space with guidance from greedy optimizers to learn from trials, which is often computationally prohibitive (e.g., training time varies from days to weeks). Existing AutoML methods mainly aim to improve the modeling accuracy (i.e., dataset-AI method interaction) for a given dataset but they discover no knowledge about the reproducibility of AI methods, and they provide no validation of data quality. In other words, the datasets and AI methods are currently isolated in literature, similar to the isolated communities prior to the Age of Discovery. Hence, a “map” is needed to guide the users to explore the world of AI which is composed of datasets, AI methods, and their interactions.

Several key challenges prevent the development of such a map. First, it is unclear how to define a latent numerical representation of different datasets, different AI methods (e.g., different sequences of AI method configuration options), and their interactions (e.g., an AI method's performance on a dataset) to quantify their similarities. Such a latent numerical representation is challenging due to the multimodal characteristics of datasets, the unstructured text descriptions of AI methods, and the variability of the interactions (e.g., some AI methods without global optima guarantee yield uncertainties in prediction performance). Second, it is also challenging to enforce such a latent numerical representation to be compatible with the capability of human perception, which usually requires an extremely low-dimensional representation with dimension less than three. Widely applied linear dimension reduction methods, such as principal component analysis (PCA), subset selection methods, and dictionary learning methods, cannot be readily adopted for extremely low-dimensional representation due to the trade-off between the dimension and information loss. To achieve lower dimensions with lower information loss, highly nonlinear dimension reduction methods should be considered. Third, visual continuity is usually not considered in dimension reduction methods. As referenced herein, “visual continuity” refers to the continuity of an interaction surface on a latent representation of datasets and AI methods. Such visual continuity can be understood as clusters of datasets and AI methods which yields similar interactions, hence being important for humans to easily understand the similarity among datasets, AI methods, and their interactions delivered by the map.

As noted above, AutoML approaches have recently been used to facilitate computation pipeline and dataset exploration for purposes of recommending an AI method (e.g., a certain computation pipeline amongst a number of different computation pipeline candidates) for a particular task. This is because conventional machine learning model development is a very labor-intensive task, e.g., it usually requires significant time as well as domain knowledge to create and compare dozens of models. Therefore, AutoML approaches have recently been studied to automate the time-consuming and resource-intensive tasks of machine learning model development and model selection for a given dataset by exploiting diverse and complex configuration of machine learning pipelines.

To explore the complex and high dimensional optimization space resulting from different configurations of machine learning pipelines, AutoML methods provide some tools, such as tree-based pipeline optimization tool (TPOT), Auto-WEKA, and Auto-Sklearn. However, these methods mostly work for non-neural ML models (e.g., support vector machines (SVM) and k-nearest neighbors (KNN), among others) and rely on heuristic approaches (e.g., greedy, beam searching, or random sampling techniques). These heuristic searching approaches are sometimes overly sensitive to their initialization step. Also, based on the different levels of entropy in the searching and sampling strategies, these heuristic approaches may either be computationally too expensive and require a large number of iterations to find top-N pipeline recommendations, or they may deliver poor model selections due to the limited backtracking and significant sensitivity to the initial selection.

Researchers have also studied the automated model selection problem as the model recommendation task in which the recommendation systems (e.g., collaborative filtering) can be employed to address limitations of the above heuristic approaches and sometimes speed-up this exploration process, and efficiently recommend top-performing ML pipelines for a given dataset. For example, OBOE and TensorOBOE are recently proposed recommendation-based collaborative filtering approaches for the effective and time-constrained ML pipeline selection task. These methods adopt matrix completion problem for the cross-validated errors of a large number of supervised learning pipelines on a large number of datasets and fit the low-rank matrix completion model to learn the low-dimensional feature vectors and predict the missing results for the performance of each pipeline on a given dataset.

However, neither OBOE nor TensorOBOE can directly address the cold-start recommendation problem with few completely empty row(s) which are usually associated with new datasets that have no prior results of ML pipelines. Therefore, in the case of providing model recommendation for a new dataset, these methods need to first convert the cold-start matrix completion problem to the warm-start problem by filling in some entries through test runs on several randomly selected pipelines. This process will be time-consuming for ML pipelines with complex nonlinear sub-steps (e.g., deep neural networks) and may cause bias and uncertainty in the final pipeline recommendation task. In other words, the test runs are usually not optimized to ensure the recommendation accuracy, hence, unstable recommendation results may be provided with strong dependency on the random selection of pipelines for test runs. Moreover, in the model selection problem, the ranking or cluster-wised ranking of recommended ML pipelines for a given dataset is more important than their predicted value of cross-validated errors. Therefore, instead of just predicting the value of cross-validated errors, the model should also consider ranking prediction of the recommended pipelines.

The adaptive computation pipeline (AdaPipe) method was recently proposed to address these limitations of the above model recommendation methods in two ways. First, It systematically considers the cold-start problem in the recommendation formulation through quantifying the explicit similarities among auxiliary covariates as well as the implicit similarities among entries of a recommendation matrix (e.g., the matrix with entries as cross-validated error of executing each pipeline on each dataset). Second, AdaPipe concentrates on the learning-to-rank property of the recommendation through ranking the candidate options with pair-wise comparisons instead of the traditional point-wise comparisons. In this way, AdaPipe compromises the prediction accuracy, but encourages the pairwise ranking performance, hence achieving more accurate ranking for existing pipelines on new datasets.

In order to better understand the geometric and spatial patterns of high dimensional datasets, statistical data visualization based on dimensionality reduction (DR) techniques has lately attracted a lot of interest. There are two main types of DR techniques for statistical data visualization: (1) local methods and (2) global methods. The goal of the local methods is to mainly preserve the set of high dimensional neighbors for each data point in the lower dimensional latent-space. The goal of the global methods is to mainly preserve the relative distances between points in the lower dimensional latent-space, particularly, distances between points which are further apart. Principal component analysis (PCA) and multidimensional scaling (MDS) are two examples of these global methods since the transformations of these approaches are incapable of capturing complicated nonlinear structures. The locally linear embedding (LLE), Isomap, and Laplacian Eigenmaps are examples of traditional local methods that have been proposed to preserve raw local distances. These methods all try to keep local Euclidean distances from the original space when building the embeddings. However, these approaches were mostly ineffective since distances in high-dimensional spaces tend to concentrate and become essentially similar, therefore preserving raw distances did not always imply preserving neighborhood structure. So, the field of local statistical visualization methods moved away from preserving raw distances to preserving the graph structures of the data (i.e., neighbor structures).

Later, stochastic neighborhood embedding (SNE) was introduced, which measured the similarities based on conditional probabilities instead of the Euclidean distances. In other words, SNE ensures the conditional probabilities of the lower dimensions are similar to the conditional probabilities of the higher dimensions. The t-distributed SNE (t-SNE) is an improved version of SNE that addressed the crowding problem (i.e., points land on top of each other in the lower dimensional space) by assuming the long-tailed t-distributions in the low dimensional latent-space. Inspired by t-SNE, the LargeVis and uniform manifold approximation and projection (UMAP) have been proposed to improve t-SNE in terms of efficiency (i.e., running time), k-nearest neighbor (KNN) accuracy, and the global structure preservation. However, all these methods are still vulnerable to some inherent weaknesses of t-SNE such as the loss of global structure, the huge requirement of hyperparameter tuning, and the presence of some misleading clusters.

The present disclosure provides solutions to address the above-described problems associated with computation pipeline and dataset exploration in general and with respect to visualizing such exploration. For example, the LNR system described herein may be embodied and implemented as a recommender-based visualization framework for effectively learning interactive clustering patterns of different datasets and different computation pipelines by learning various covariates of such datasets and computation pipelines in a low-dimensional latent-space. The LNR system can further predict dataset-pipeline interactions between the different computation pipelines and the different datasets based on the interactive clustering patterns and/or covariates. The LNR system can also generate a visual representation of the interactive clustering patterns and the predicted dataset-pipeline interactions.

Motivated by the world map that visualizes the distance and similarity of landscapes as an intuitive tool to guide voyagers towards their destinations, the LNR system provides a visualization component called “World Map of AI” (or “AI Map”) as a visualization framework to facilitate exploration in the space of different datasets, different computation pipelines (e.g., different sequences of AI method configuration options), and their interactions (e.g., performance of each computation pipelines using each dataset). For example, the visualization framework can be used to generate visual representations that visualize the distance and similarity among different datasets and different AI methods. As noted above, constructing an AI Map is challenging. This is partly because constructing an AI Map involves strong reliance on the unique numerical representations of datasets, AI methods, as well as accurate predictions of their interactions (e.g., an AI method's performance on a dataset) before an AI method is tested on a particular dataset. Moreover, restricted by human perception of dimensions, such an AI Map representation should be low-dimensional (e.g., less than three dimensions), but sufficiently informative to guide users' searching on this map. The LNR system addresses these challenges to achieve such an AI Map representation by jointly generating two-dimensional latent spaces for datasets and AI methods, respectively, and predicting their interactions.

The LNR system may also implement a hybrid loss function that integrates three types of objectives: a recommendation loss, a reconstruction loss, and a continuity loss. In one example, the recommendation loss aims at achieving higher cluster-wised ranking prediction accuracy for the pipeline recommendation task by considering both implicit and explicit recommendation feedback. In one example, the reconstruction loss aims at achieving distribution latent representation learning with the purpose of providing meaningful clustering patterns in the latent space. Therefore, the latent generation approach implemented by the LNR system in examples described herein can allow the LNR system to learn more robust features with smoother latent-space representations thanks to the maintenance of general distribution and the choice of probabilistic representation achieved by encoder-decoder network structure. In one example, the continuity loss aims at achieving a defined visualization profile continuity and/or smoothness of an interaction surface in an AI Map visual representation of interactive clustering patterns and predicted dataset-pipeline interactions of different computation pipelines and different datasets. In some cases, the continuity loss can be tuned according to different desired levels of general continuity in a final three-dimensional (3D) visualization (e.g., a 3D AI Map) described herein.

The LNR system of the present disclosure provides several technical benefits and advantages. For example, to provide a visualization approach that can effectively and efficiently capture all different types of similarities in a cost-effective manner while providing perceivable information for a user, the LNR system can combine recommendation and variational latent-space generation techniques. For instance, the LNR system can take informative low-dimensional abstractive features of both datasets and AI methods simultaneously as input, similar to a two-modal model with one modal referring to datasets and the other to AI methods. Then, the LNR system can use two encoder-decoder network structures in some cases to capture the distribution among datasets and AI methods in such informative low-dimensional abstractive features. In some examples, the LNR system can then incorporate these low-dimensional features in a neural matrix factorization structure that predicts the dataset-pipeline interactions.

Additionally, the AI Map described in examples herein can serve as an interactive bridge between two worlds (i.e., between spaces in which AI methods and datasets are respectively defined): (1) the world of AI methods (i.e., computation pipelines); and (2) the world of datasets. In one example AI Map, the latitude and longitude of both the dataset world and the AI method world are generated based on the latent variable space of two parallel encoder-decoder network structures, and the altitudes (i.e., predicted dataset-pipeline interactions) are created by the neural matrix factorization structure. The world of AI methods (i.e., computation pipelines) can help researchers and practitioners to find out where their proposed method stands in terms of performance (i.e., what is the relative scope of a certain AI method in comparison to other AI methods in various contexts). The world of datasets can help researchers to detect the level of consistency for the performance of the same AI method among different datasets (i.e., the relative quality of datasets), with the greatest and worst levels of quality displayed as peaks and valleys in some example AI Maps of the present disclosure.

By studying the boundaries of dataset's and pipeline's quality regions in the world of datasets and the world of pipelines, respectively, one can better understand why these variations occur in the performance levels. Interpreting these boundaries can also guide researchers to perform proper troubleshooting and recovering steps towards the boosted performance of a computation pipeline in different contexts; or boosted quality of a dataset in different tasks. For instance, as described herein, the LNR system can learn and describe the interactive clustering patterns of datasets and ML pipelines in the low-dimensional latent space. As such, the LNR system can help users to better understand the similarities among datasets and computation pipelines which lead to different model recommendations as well as different levels of data quality and pipeline performance. In addition, the AI Map described herein can contribute to the reproducibility and generalizability verification of AI methods by providing broad comparisons for the interaction of computation pipelines with different and diverse datasets. All these comprehensive evaluations can help researchers invest in some areas that may be considered unpromising such as improving the performance of certain types of methods in different contexts of datasets.

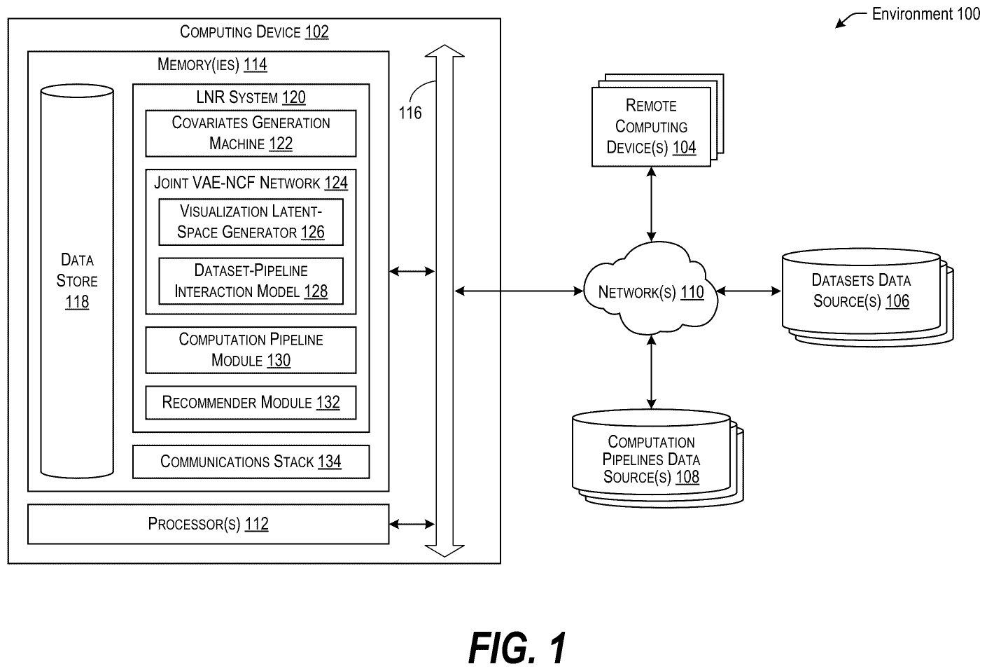

FIG. 1 illustrates a block diagram of an example environment 100 that can facilitate visualization of computation pipeline and dataset exploration according to at least one embodiment of the present disclosure. The environment 100 is an example computing environment in which computation pipeline and dataset exploration, visualization, and recommendation operations, among others, may be performed by one or more computing devices in accordance with various examples described herein. For example, the environment 100 is an example computing environment in which a computing device can analyze the performance of different computation pipelines with respect to different datasets, visualize such an analysis in an informative and perceivable manner, and provide insights and/or recommendations in connection with the different computation pipelines or the different datasets based on the analysis and visual representations of the same. The environment 100 is illustrated as a representative example, and the LNR system concepts described herein are not limited to use with any particular type of computing environment or any particular types of datasets.

In the example illustrated in FIG. 1, the environment 100 includes a computing device 102, one or more remote computing devices 104 (or “remote computing devices 104”), one or more datasets data sources 106 (or “datasets data sources 106”), and one or more computation pipelines data sources 108 (or “computation pipelines data sources 108”), among other components. In this example, the computing device 102, the remote computing devices 104, the datasets data sources 106, and the computation pipelines data sources 108 are coupled to one another by way of one or more networks 110 (or “networks 110”).

The computing device 102 and any or all of the remote computing devices 104 can each be embodied or implemented as, for example, at least one of a server computing device, a client computing device, a general-purpose computer, a special-purpose computer, a virtual machine, a supercomputer, a quantum computer or processor, a laptop, a tablet, a smartphone, or another type of computing device that can be configured and operable to perform various operations described herein. A detailed description of the computing device 102 and the operations it can perform is provided herein.

The datasets data sources 106 may include or provide one or more datasets and/or data indicative thereof, such as the datasets described herein and/or data indicative thereof, for example. In one example, the datasets data sources 106 may include raw datasets including various data types or formats. In another example, the datasets data sources 106 may include summary statistics data respectively corresponding to different datasets. In one example, the datasets data sources 106 may include summary statistics data respectively corresponding to different time series classification datasets. In another example, the datasets data sources 106 may include summary statistics data indicative of at least one of a lower quantile, upper quantile, interquartile range, or coefficient of variation associated with a certain dataset.

The computation pipelines data sources 108 may include or provide data indicative of one or more computation pipelines, such as the different computation pipelines described herein, for example. In many examples, the computation pipelines data sources 108 may include data indicative of explanations and comparisons of various method component options for one or more computation pipelines. In one example, the computation pipelines data sources 108 may include data in the form of a corpus of text documents that include explanations and comparisons of various method component options for one or more computation pipelines.

The networks 110 can include, for instance, the Internet, intranets, extranets, wide area networks (WANs), local area networks (LANs), wired networks, wireless networks (e.g., cellular, WiFi®), cable networks, satellite networks, other suitable networks, or any combinations thereof. The computing device 102, the remote computing devices 104, the datasets data sources 106, and the computation pipelines data sources 108 can communicate data with one another over the networks 110 using any suitable systems interconnect models and/or protocols. Example interconnect models and protocols include hypertext transfer protocol (HTTP), simple object access protocol (SOAP), representational state transfer (REST), real-time transport protocol (RTP), real-time streaming protocol (RTSP), real-time messaging protocol (RTMP), user datagram protocol (UDP), internet protocol (IP), transmission control protocol (TCP), and/or other protocols for communicating data over the networks 110, without limitation. Although not illustrated, the networks 110 can also include connections to any number of other network hosts, such as website servers, file servers, networked computing resources, databases, data stores, or other network or computing architectures in some cases.

Among other types of operations, the computing device 102 can be configured to combine recommendation and variational latent-space generation methods to effectively learn interactive clustering patterns of different datasets and different computation pipelines in a low-dimensional latent-space. The computing device 102 can further predict dataset-pipeline interactions between the different computation pipelines and the different datasets (i.e., performance of the different computation pipelines with respect to the different datasets). The computing device 102 can also generate a visual representation of the interactive clustering patterns and the predicted dataset-pipeline interactions. Additionally, the computing device 102 can provide at least one of insights, recommendations, or rankings associated with the different computation pipelines and the different datasets based on the analysis and visual representation.

To perform the computation pipeline and dataset exploration, visualization, and/or recommendation operations described in various examples herein, among other operations, the computing device 102 can include at least one processing and memory system. In the example depicted in FIG. 1, the computing device 102 includes at least one processor 112 and at least one memory 114, both of which are communicatively coupled, operatively coupled, or both, to a local interface 116. The memory 114 includes a data store 118, a latent neural recommender system 120 (or “LNR system 120”), a covariates generation machine 122, a joint variational autoencoder neural collaborative filtering network 124 (or “joint VAE-NCF network 124”), a visualization latent-space generator 126, a dataset-pipeline interaction model 128, a computation pipeline module 130, a recommender module 132, and a communications stack 134 in the example shown. The computing device 102 is coupled to the networks 110 by way of the local interface 116 in this example. In some cases, the computing device 102 can also include other components that are not illustrated in FIG. 1. In other cases, one or more components of the computing device 102 shown in FIG. 1 may be omitted.

The processor 112 can be embodied as or include any processing device (e.g., a processor core, a microprocessor, an application specific integrated circuit (ASIC), a field-programmable gate array (FPGA), a controller, a microcontroller, or a quantum processor) and can include one or multiple processors that can be operatively connected. In some examples, the processor 112 can include one or more complex instruction set computing (CISC) microprocessors, one or more reduced instruction set computing (RISC) microprocessors, one or more very long instruction word (VLIW) microprocessors, or one or more processors that are configured to implement other instruction sets.

The memory 114 can be embodied as one or more memory devices and can store data and software or executable-code components executable by the processor 112. For example, the memory 114 can store executable-code components associated with the LNR system 120, the covariates generation machine 122, the joint VAE-NCF network 124, the visualization latent-space generator 126, the dataset-pipeline interaction model 128, the computation pipeline module 130, the recommender module 132, and the communications stack 134 for execution by the processor 112. The memory 114 can also store data such as the data described below that can be stored in the data store 118, among other data. For instance, the memory 114 can also store data indicative of at least one of the different datasets, the datasets summary statistics data, the different computation pipeline descriptions data, the recommendation matrix, or the visual representations described herein, among other data.

The memory 114 can store other executable-code components for execution by the processor 112. For example, an operating system can be stored in the memory 114 for execution by the processor 112. Where any component discussed herein is implemented in the form of software, any one of a number of programming languages can be employed such as, for example, C, C++, C#, Objective C, JAVA®, JAVASCRIPT®, Perl, PHP, VISUAL BASIC®, PYTHON®, RUBY, FLASH®, or other programming languages.

As discussed above, the memory 114 can store software for execution by the processor 112. In this respect, the terms “executable” or “for execution” refer to software forms that can ultimately be run or executed by the processor 112, whether in source, object, machine, or other form. Examples of executable programs include, for instance, a compiled program that can be translated into a machine code format and loaded into a random access portion of the memory 114 and executed by the processor 112, source code that can be expressed in an object code format and loaded into a random access portion of the memory 114 and executed by the processor 112, source code that can be interpreted by another executable program to generate instructions in a random access portion of the memory 114 and executed by the processor 112, or other executable programs or code.

The local interface 116 can be embodied as a data bus with an accompanying address/control bus or other addressing, control, and/or command lines. In part, the local interface 116 can be embodied as, for instance, an on-board diagnostics (OBD) bus, a controller area network (CAN) bus, a local interconnect network (LIN) bus, a media oriented systems transport (MOST) bus, ethernet, or another network interface.

The data store 118 can include data for the computing device 102 such as, for instance, one or more unique identifiers for the computing device 102, digital certificates, encryption keys, session keys and session parameters for communications, and other data for reference and processing. The data store 118 can also store computer-readable instructions for execution by the computing device 102 via the processor 112, including instructions for the LNR system 120, the covariates generation machine 122, the joint VAE-NCF network 124, the visualization latent-space generator 126, the dataset-pipeline interaction model 128, the computation pipeline module 130, the recommender module 132, and the communications stack 134. In some cases, the data store 118 can also store data indicative of at least one of the different datasets, the datasets summary statistics data, the different computation pipeline descriptions data, the recommendation matrix, or the visual representations described herein, among other data.

The LNR system 120 can be embodied as one or more software applications or services executing on the computing device 102. For example, the LNR system 120 can be embodied as and can include the covariates generation machine 122, the joint VAE-NCF network 124, the computation pipeline module 130, the recommender module 132, and other executable modules or services. The LNR system 120 can be executed by the processor 112 to implement at least one of the covariates generation machine 122, the joint VAE-NCF network 124, the computation pipeline module 130, or the recommender module 132. Each of the covariates generation machine 122, the joint VAE-NCF network 124, the computation pipeline module 130, and the recommender module 132 can also be respectively embodied as one or more software applications or services executing on the computing device 102.

In one example, the LNR system 120 can be executed by the processor 112 to learn interactive clustering patterns of different datasets and different computation pipelines in a low-dimensional latent-space (e.g., a two-dimensional latent-space). The LNR system 120 can further predict dataset-pipeline interactions between the different computation pipelines and the different datasets (e.g., performance of the different computation pipelines with respect to the different datasets). The LNR system 120 can also generate a visual representation of the interactive clustering patterns and the predicted dataset-pipeline interactions. Additionally, the LNR system 120 can provide at least one of insights, recommendations, or rankings associated with the different computation pipelines and the different datasets based on the analysis and visual representation.

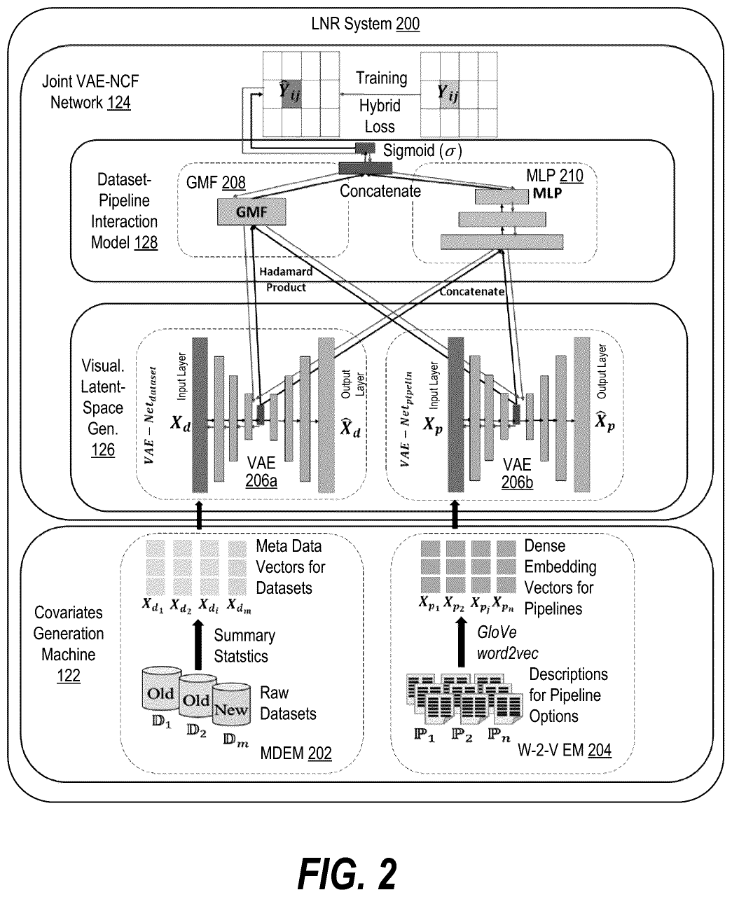

To perform such learning, predicting, visualizing, and recommendation operations, the LNR system 120 can implement one or more of the covariates generation machine 122, the joint VAE-NCF network 124 (e.g., the visualization latent-space generator 126 and the dataset-pipeline interaction model 128), the computation pipeline module 130, the recommender module 132, or the communications stack 134 according to examples described herein. In one particular example, the LNR system 120 can perform one or more of such learning, predicting, visualizing, and recommendation operations as described herein with reference to FIG. 2.

The covariates generation machine 122 can be embodied as one or more software applications or services executing on the computing device 102. The covariates generation machine 122 can be executed by the processor 112 to generate meta-data vectors respectively corresponding to different datasets obtained from the datasets data sources 106. In one example, the covariates generation machine 122 can generate the meta-data vectors based on summary statistics data corresponding to the different datasets. In this example, the summary statistics data may be obtained from the datasets data sources 106 or generated by the LNR system 120 or the covariates generation machine 122 using one or more datasets obtained from the datasets data sources 106. For instance, the LNR system 120 may employ a web crawler application (also, “spider” or “search engine bot”) to learn, extract, or otherwise obtain one or more datasets and/or summary statistics data indicative and corresponding to the different datasets from the datasets data sources 106. In one particular example, the covariates generation machine 122 can generate the meta-data vectors as described herein with reference to FIG. 2.

The covariates generation machine 122 can be further executed by the processor 112 to generate embedding vectors respectively corresponding to the different computation pipelines based on data indicative of different pipeline component candidates of the different computation pipelines. In one example, the covariates generation machine 122 can generate dense embedding vectors based on one or more text documents obtained from the computation pipelines data sources 108. In this example, the text documents individually or collectively include explanations and comparisons of various method component options for the different computation pipelines. For instance, the LNR system 120 may employ a web crawler application (spider, search engine bot) to learn, extract, or otherwise obtain such explanation and comparison data from the computation pipelines data sources 108. For example, the LNR system 120 may employ the same or different web crawler application as that described above with reference to collecting datasets and/or summary statistics data of datasets from the datasets data sources 106. In one particular example, the covariates generation machine 122 can generate the embedding vectors as described herein with reference to FIG. 2.

The joint VAE-NCF network 124 can be embodied as one or more software applications or services executing on the computing device 102. For example, the joint VAE-NCF network 124 can be embodied as and can include the visualization latent-space generator 126, the dataset-pipeline interaction model 128, and other executable modules or services. The joint VAE-NCF network 124 can be executed by the processor 112 to implement at least one of the visualization latent-space generator 126 or the dataset-pipeline interaction model 128. Each of the visualization latent-space generator 126 and the visualization latent-space generator 126 can also be respectively embodied as one or more software applications or services executing on the computing device 102.

In one example, the joint VAE-NCF network 124 can be executed by the processor 112 to learn first visualization latent-space features of different datasets (or “datasets visualization latent-space features”) represented in a first two-dimensional (2D) latent space and second visualization latent-space features of different computation pipelines (or “pipelines visualization latent-space features”) represented in a second 2D latent space. The joint VAE-NCF network 124 can further model (e.g., predict) dataset-pipeline interactions between the different datasets and the different computation pipelines in this example based on the datasets visualization latent-space features and the pipelines visualization latent-space features. Additionally, the joint VAE-NCF network 124 can learn relationships (e.g., covariates, interactive clustering patterns) between the datasets visualization latent-space features and the pipelines visualization latent-space features based on modeling (e.g., predicting) the dataset-pipeline interactions (e.g., performance data of each of the computation pipelines with respect to each of the datasets).

To perform such learning and modeling (e.g., predicting) operations, the joint VAE-NCF network 124 can implement one or more of the visualization latent-space generator 126 and the dataset-pipeline interaction model 128 according to examples described herein. In one particular example, the joint VAE-NCF network 124 can perform one or more of such learning and modeling (e.g., predicting) operations as described herein with reference to FIG. 2.

The visualization latent-space generator 126 can be embodied as one or more software applications or services executing on the computing device 102. The visualization latent-space generator 126 can be executed by the processor 112 to implement at least one autoencoder (AE) such as, for instance, at least one variational autoencoder (VAE) to learn the aforementioned datasets visualization latent-space features and the aforementioned pipelines visualization latent-space features. In one example, the visualization latent-space generator 126 can implement two structurally symmetric VAEs to respectively learn the datasets visualization latent-space features in the first 2D latent space and the pipelines visualization latent-space features in the second 2D latent space. For instance, the visualization latent-space generator 126 can implement the two structurally symmetric VAEs in parallel (e.g., concurrently, simultaneously) to respectively learn the datasets visualization latent-space features in the first 2D latent space and the pipelines visualization latent-space features in the second 2D latent space.

In this example, the visualization latent-space generator 126 can use a first of the two structurally symmetric VAEs to generate first visualization latent-space representations of the different datasets (or “datasets visualization latent-space representations”) in the first 2D latent space based on meta-data vectors corresponding to and indicative of the different datasets. The visualization latent-space generator 126 can use the first of the two structurally symmetric VAEs to learn the datasets visualization latent-space features in the first 2D latent space based on the datasets visualization latent-space representations. In this example, the visualization latent-space generator 126 can use a second of the two structurally symmetric VAEs to generate second visualization latent-space representations of the different computation pipelines (or “pipelines visualization latent-space representations”) in the second 2D latent space based on embedding vectors corresponding to and indicative of the different computation pipelines. The visualization latent-space generator 126 can use the second of the two structurally symmetric VAEs to learn the pipelines visualization latent-space features in the second 2D latent space based on the pipelines visualization latent-space representations. In one particular example, the visualization latent-space generator 126 can implement the two structurally symmetric VAEs as described herein with reference to FIG. 2.

The dataset-pipeline interaction model 128 can be embodied as one or more software applications or services executing on the computing device 102. The dataset-pipeline interaction model 128 can be executed by the processor 112 to model (e.g., predict) the aforementioned dataset-pipeline interactions based on the datasets visualization latent-space features and the pipelines visualization latent-space features. In one example, to model the dataset-pipeline interactions, the dataset-pipeline interaction model 128 can implement a neural collaborative filtering (NCF) network to predict performance metrics (e.g., accuracy) of different computation pipelines with respect to the different datasets based on the datasets visualization latent-space features and the pipelines visualization latent-space features. For instance, the dataset-pipeline interaction model 128 can implement an NCF network to model the dataset-pipeline interactions using a neural collaborative filtering process. In this example, the NCF process can include generalized matrix factorization (GMF) of a recommendation matrix (or “response matrix”) generated by the NCF network and multi-layer projection (MLP) of the datasets visualization latent-space features and the pipelines visualization latent-space features. In one particular example, the dataset-pipeline interaction model 128 can model the dataset-pipeline interactions using an NCF network and process as described herein with reference to FIG. 2.

To augment the learning, predicting, visualizing, and recommendation operations described herein, the LNR system 120 may be trained using a hybrid loss function. For instance, when performing such operations, the LNR system 120 may also implement a hybrid loss function having a recommendation loss component, a reconstruction loss component, and a continuity loss component. In one example, the recommendation loss component drives the joint VAE-NCF network 124 toward a defined (e.g., desired) cluster-wised ranking prediction accuracy and the reconstruction loss component drives the joint VAE-NCF network 124 toward a defined (e.g., desired) visualization latent-space representation generation accuracy in the aforementioned first and second 2D latent spaces. The continuity loss component in this example drives the joint VAE-NCF network 124 toward a defined visualization profile continuity and smoothness of an interactive surface of a visual representation of the aforementioned relationships and dataset-pipeline interactions. In one particular example, the LNR system 120 can implement the hybrid function as described herein with reference to FIG. 2.

The computation pipeline module 130 can be embodied as one or more software applications or services executing on the computing device 102. The computation pipeline module 130 can be executed by the processor 112 to generate different computation pipelines that are each indicative of and correspond to a unique AI model. Each computation pipeline, and thus each corresponding unique AI model, is defined as a unique sequence of different AI method options (i.e., AI method component candidates) that can be implemented sequentially to perform different AI operations. For example, the computation pipeline module 130 can configure and/or operate with or on the different computation pipelines described herein.

The recommender module 132 can be embodied as one or more software applications or services executing on the computing device 102. The recommender module 132 can be executed by the processor 112 to evaluate one or more computation pipelines with respect to different datasets and identify the relatively best computation pipelines for use with a particular task or contextual dataset. For example, the recommender module 132 can evaluate different computation pipelines with respect to the different datasets described herein. The identified or selected computation pipelines can be those that meet certain requirements or criteria, lead to certain decisions or outcomes, or fit other requirements.

The recommender module 132 can provide computation pipeline recommendations in the form of, for example, a recommendation matrix (also referred to as a “response matrix”). The recommendation matrix can include data representative of different computation pipelines that have been evaluated by the LNR system 120 and the recommender module 132 with respect to different contexts or datasets. In some cases, the recommender module 132 can also generate a recommendation of one or more computation pipelines in the recommendation matrix that are relatively best suited for a particular context or dataset based on ranking such one or more computation pipelines with respect to such a context or dataset.

For instance, the recommender module 132 can generate the recommendation matrix such that it includes a ranking value for each computation pipeline with respect to each of a number of different contexts or datasets. To provide a recommendation or a ranking, the recommender module 132 can assign the ranking values based on empirical or predicted performance data corresponding to each computation pipeline for each of the different contexts or datasets. The performance data can be indicative of the respective performance accuracy of each computation pipeline with respect to each of the different contexts or datasets. For example, the performance data can be indicative of how accurately or inaccurately each respective computation pipeline performs compared to the other computation pipelines with respect to each of the different contexts or datasets.

In some cases, the LNR system 120 can obtain performance data by individually implementing each computation pipeline using one of the datasets for each implementation. In these cases, the performance data can be indicative of observed or empirical performance data. In other cases, the LNR system 120 can predict at least a portion of the performance data. For instance, the LNR system 120 may encounter new datasets, contexts, or computation pipelines in some cases. For example, some datasets may include new context data that has not been previously used by the LNR system 120 to evaluate computation pipelines. In these examples, the LNR system 120 may therefore lack at least some observed or previously predicted performance data for one or more particular computation pipelines with respect to such new data contexts or datasets. In these cases, the LNR system 120 can predict such missing performance data. Based at least in part on such predicted performance data, the recommender module 132 can then, for instance, recommend and/or rank one or more particular computation pipelines for use with the new context data or datasets. The ranking can be performed with respect to other contextual datasets as well.

The communications stack 134 can include software and hardware layers to implement data communications such as, for instance, Bluetooth®, Bluetooth® Low Energy (BLE), WiFi®, cellular data communications interfaces, or a combination thereof. Thus, the communications stack 134 can be relied upon by the computing device 102 to establish cellular, Bluetooth®, WiFi®, and other communications channels with the networks 110 and with at least one of the remote computing devices 104, the datasets data sources 106, or the computation pipelines data sources 108.

The communications stack 134 can include the software and hardware to implement Bluetooth®, BLE, and related networking interfaces, which provide for a variety of different network configurations and flexible networking protocols for short-range, low-power wireless communications. The communications stack 134 can also include the software and hardware to implement WiFi® communication, and cellular communication, which also offers a variety of different network configurations and flexible networking protocols for mid-range, long-range, wireless, and cellular communications. The communications stack 134 can also incorporate the software and hardware to implement other communications interfaces, such as X10®, ZigBee®, Z-Wave®, and others. The communications stack 134 can be configured to communicate various data or information amongst the remote computing devices 104, the datasets data sources 106, and the computation pipelines data sources 108. Examples of such data or information can include, but are not limited to, at least one of the different datasets, the datasets summary statistics data, the different computation pipeline descriptions data, the recommendation matrix, or the visual representations described herein, among other data.

In some cases, the computing device 102 can implement the LNR system 120 as a service. For instance, in some cases, one or more of the remote computing devices 104 can send a request (e.g., via the networks 110) to the computing device 102 requesting the computing device 102 to provide at least one of an analysis of the performance of various computation pipelines with respect to various datasets, one or more informative and perceivable visualizations of such a pipeline-dataset analysis, or insights and/or recommendations in connection with one or both of the computation pipelines and the datasets based on the analysis and visual representations of the same. In one example, the remote computing device 104 can send a request to identify one or more previously evaluated computation pipelines that perform relatively best with respect to a certain previously evaluated dataset or datasets, or subsets thereof. In another example, the remote computing device 104 can provide the computing device 102 with a new dataset or datasets for evaluation independent of any previous pipeline-dataset evaluations preformed, or in addition to such previous pipeline-dataset evaluations in some cases.

In the example illustrated in FIG. 1, any or all of the remote computing devices 104 can be owned by and/or operated by, or on behalf of, an entity such as, for instance, an enterprise, an organization, a company, another type of entity, or any combination thereof. For example, the entity can be an enterprise such as, for instance, a manufacturing enterprise, another type of enterprise, or any combination thereof. In one example, a plurality of such entities can respectively operate one or more types of machines, instruments, or equipment, perform one or more types of processes, use one or more types of materials or recipes, produce one or more types of products, provide one or more types of services, or any combination thereof. The entities can be heterogeneous or homogeneous with respect to one another. For instance, one or more of the operations, machines, instruments, equipment, processes, materials, recipes, products, services, and the like, of any of the entities can be the same as, similar to, or different from that of any of the other entities.

Additionally, the entities can individually perform data-driven decision-making tasks as part of the operations undertaken by the entities. The data-driven decision-making tasks can be associated with or specific to a particular context. For instance, such data-driven decision-making tasks can be associated with or specific to a particular context related to their respective operations, machines, instruments, equipment, processes, materials, recipes, products, services, and the like. To perform the data-driven decision-making tasks, any or all of the entities can individually implement one or more AI models and/or methods. Use of the AI models can improve the data-driven decision-making tasks or the outcomes of those tasks in many cases, saving time, costs, and leading to other benefits.

Although not illustrated in FIG. 1 for clarity purposes, the entities can each include or be coupled (e.g., communicatively, operatively) to one or more data collection devices that can measure or capture local data that can be respectively associated with the entities. Examples of such data collection devices can include, but are not limited to, one or more sensors, actuators, instruments, manufacturing tools, programmable logic controllers (PLCs), Internet of Things (IoT) devices, Industrial Internet of Things (IIoT) devices, or any combination thereof. Additionally, each of the remote computing devices 104 can be coupled (e.g., communicatively, operatively) to the data collection devices of the respective entities. In this way, the remote computing devices 104 can each receive the local data of their corresponding entity.

The local data can correspond to, be associated with, and be owned by the respective entities. Among other types of data, the local data can include sensor data, annotated sensor data, another type of local data, or any combination thereof. The sensor data can be respectively captured or measured locally by any of the entities. The annotated sensor data can include sensor data that has been respectively captured or measured locally by any of the entities and further independently annotated by the entities that locally captured or measured such sensor data. The sensor data, the annotated sensor data, or both can be stored locally by any of the entities that captured or measured the sensor data or created the annotated sensor data.

In some cases, the local data can include or be indicative of at least one of multivariate or time series data such as, for instance, multivariate time series (MTS) data. In some examples, the local data can include or be indicative of one or more contexts. For instance, the local data can include or be indicative of one or more contexts related to the respective operations, machines, instruments, equipment, processes, materials, recipes, products, services, and the like of the entities. Example contexts for each of the local data can include, but are not limited to, sample sizes, data distributions, data analytics objectives, requirements on performance and runtime metrics, custom designs, personalized specifications, process settings, another context, or any combination thereof.

The local data can be respectively used by the entities to individually perform data-driven decision-making tasks in connection with their respective operations, machines, instruments, equipment, processes, materials, recipes, products, services, and the like. In some cases, the local data can be respectively generated by the entities as a result of performing data-driven decision-making tasks in connection with their respective operations, machines, instruments, equipment, processes, materials, recipes, products, services, and the like. In one example, the local data can be respectively used by the entities to individually train, implement, and/or evaluate at least one of an ML model, an AI model, or another model that can perform data-driven decision-making tasks with respect to a certain context. The datasets of different entities can be used to train, implement, and/or evaluate such an ML and/or AI model with respect to different contexts. In one example, the computing device 102 and the remote computing devices 104 can use any of such datasets to individually train, implement, and/or evaluate such an ML and/or AI model with respect to one or more contexts. Among all the AI models available, certain AI models may be better suited for data-driven decision-making tasks and outcomes with respect to a certain context based on a range of factors.

In one example, to determine which AI models perform relatively best for certain contexts or datasets, or to identify which contexts or datasets correspond to the relatively best performing AI models amongst a group of such models, the entities individually can submit the aforementioned pipeline-dataset evaluation, visualization, and/or recommendation request to the computing device 102 using the remote computing devices 104. When submitting such a request in this example, the remote computing devices 104 can provide the computing device 102 with their respective local data in the form of datasets and/or summary statistics data corresponding to such datasets. The computing device 102 can further use the networks 110 to provide the remote computing devices 104 with a response including a work product or other output generated by the LNR system 120 in response to the request.

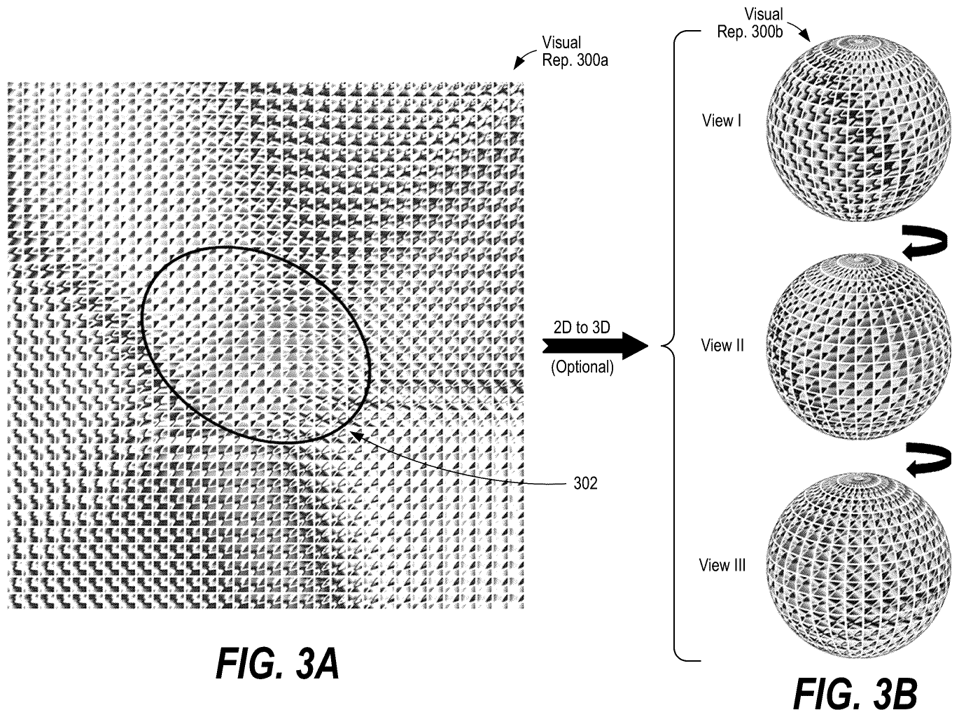

In another example, any or all of the remote computing devices 104 may include and execute the LNR system 120 and its various components in the same manner as described in examples herein with reference to the computing device 102. In such examples, the remote computing devices 104 may independently implement the LNR system 120 to perform the pipeline-dataset exploration, visualization, and/or recommendation operations described in embodiments herein. In any case, the computing device 102 or the remote computing devices 104 can implement the LNR system 120 to perform such operations before any candidate AI model is actually trained and tested, as the LNR system 120 can learn pipeline-dataset relationships and use such learned relationships to predict pipeline-dataset performance. Additionally, example work products or outputs generated by the LNR system 120 can include, but are not limited to, at least one of a recommendation matrix, a computation pipeline ranking, a computation pipeline recommendation, one or more visualizations of different pipeline-dataset relationships and pipeline-dataset performance data, or another work product or output that can be generated by the LNR system 120 according to at least one example described herein. In at least one example, the LNR system 120 can generate visualizations of learned computation pipeline-dataset relationships and predicted performance data such as the visualizations described herein and illustrated in FIGS. 3A and 3B, among other visualizations. These and other aspects of the embodiments are described in further detail below with reference to FIGS. 2, 3A, 3B, and 4.

FIG. 2 illustrates a block diagram of an example LNR system 200 that can facilitate visualization of computation pipeline and dataset exploration according to at least one embodiment of the present disclosure. The LNR system 200 is an example embodiment of the LNR system 120, and vice versa in some cases. In one example, the LNR system 200 can include the same components, attributes, and functionality, among other common aspects, as that of the LNR system 120. In another example, the LNR system 120 can include the same components, attributes, and functionality, among other common aspects, as that of the LNR system 200. In the example shown, the computation pipeline module 130 and the recommender module 132 are omitted from the LNR system 200 for clarity. FIG. 2 further illustrates example operations such as data dimension reduction, latent visualization feature learning, and modeling (e.g., predicting) of dataset-pipeline interactions (e.g., pipeline-dataset performance data), that may be performed by either or both of the LNR systems 120, 200 according to at least one embodiment of the present disclosure.

The LNR system 200 is a recommender-based visualization system that can effectively learn the interactive clustering patterns of datasets and ML pipelines in a low-dimensional (e.g., 2D) latent-space. In this example, it may be assumed that: (1) auxiliary information of pipelines is available as, for instance, text descriptions for each method option and the comparison results with benchmarks, (2) pipelines share the same steps for a certain type of computation services, and (3) datasets include different sources and pipelines come from different networks which lead to inherent cluster structures in both datasets and pipelines.

The components and methodology of the LNR system 200 include the covariates generation machine 122 that generates embedding vectors for datasets and ML pipelines. The components and methodology of the covariates generation machine 122 in this example include a meta-data extraction machine 202 (or “MDEM 202”) to generate meta-data vectors from existing raw datasets. The components and methodology of the covariates generation machine 122 in this example further include a pipeline word2vec embedding machine 204 (or “W-2-V EM 204”) to generate embedding vectors for the ML pipelines based on descriptions of their respective sequential candidate options. Then, the generated covariates may be imported to the joint VAE-NCF network 124 for the estimation and visualization analysis.

The components and methodology of the LNR system 200 further include two parallel VAEs 206a, 206b (also “VAEs 206a, 206b” or “VAE Net_{dataset}” and “VAE Netₚᵢₚₑₗᵢₙₑ”) to extract generative latent visualization features of each dataset and ML pipeline from their available auxiliary information, which may be obtained from the datasets data sources 106 and the computation pipelines data sources 108, respectively. The components and methodology of the LNR system 200 also include the dataset-pipeline interaction model 128 that combines the generated latent features of datasets and pipelines with an NCF model that includes a generalized matrix factorization (GMF) component 208 (or “GMF 204”) and a multi-layer projection (MLP) component 210 (or “MLP 206”).

Table 1 summarizes many of the notations used in the present disclosure.

TABLE 1
List of Notations

| Notation | Description |
|---|---|
| [symbol] | Set of datasets |
| [symbol] | Set of pipelines |
| m | Number of datasets |
| n | Number of pipelines |
| t | Dimension of dataset's meta-data |
| q | Dimension of pipeline's embedded vector |
| x_{di} | Meta data vector of the i-th dataset |
| xₚⱼ | Embedded vector of the j-th pipeline |
| yᵢⱼ | Explicit performance of the j-th pipeline |
| | on the i-th dataset |
| ŷᵢⱼ | Predicted performance of the j-th pipeline |
| | on the i-th dataset |
| v | Dimension of the visualization latent |
| | space for both parallel VAEs |
| z_{di} | Visualization latent vector of the i-th dataset |
| zₚⱼ | Visualization latent vector of the j-th pipeline |
| W_{d}^{l} | Weight matrix for the l-th layer of the VAE-Net_{dataset} |
| b_{d}^{l} | Bias for the l-th layer of the VAE-Net_{dataset} |
| f_{d}^{l} | Activation function for the l-th layer of the VAE-Net_{dataset} |
| Wₚ^{l} | Weight matrix for the l-th layer of the VAE-Netₚᵢₚₑₗᵢₙₑ |
| bₚ^{l} | Bias for the l-th layer of the VAE-Netₚᵢₚₑₗᵢₙₑ |
| fₚ^{l} | Activation function for the l-th layer of the VAE-Netₚᵢₚₑₗᵢₙₑ |
| L₁ | Total number of layers in the VAE networks |
| W_{dp}^{l} | Weight matrix for the l-th layer of the NCF network |
| b_{dp}^{l} | Bias for the l-th layer of the NCF network |
| f_{dp}^{l} | Activation function for the l-th layer of the NCF network |
| L₂ | Total number of layers in the NCF network |

In the example shown in FIG. 2, the MDEM 202 creates a vector of meta-data for a given dataset using summary statistics data corresponding to the dataset. Example summary statistics for the time series classification datasets are provided in Table 2 below. In Table 2, the lower quantile, upper quantile, interquartile range, and coefficient of variation are denoted as Q1, Q3, IQR, and CV, respectively. The statistics of features (e.g., mean of mean of features), may first calculate the mean of features over all the time-steps and then calculate mean of the mean values. To be more specific, the MDEM 202 may generate a t-dimensional meta-data vector x_{d}_{ᵢ}ϵ [symbol] ′ for each dataset dᵢϵ [symbol] .

TABLE 2
Example Summary Statistics Data

| | |
|---|---|
| Number of time-steps | Std. of mean of features |
| Number of features | Mean of std. of features |
| Number of classes | Max of Std. of features |
| Max of max of features | Mean of Q1 of features |
| Mean of max of features | Min of Q1 of features |
| Min of min of features | Mean of Q3 of features |
| Mean of min of features | Max of Q3 of features |
| Mean of mean of features | Mean of IQR of features |
| Max of mean of features | Mean of CV of features |
| Min of mean of features | Mean of Kurtosis of features |
| Mean of median of features | Mean of Skewness of features |

The W-2-V EM 204 may create a dense embedding vector for each pipeline in a designed ML pipeline structure. In this example, these embedding vectors may be created by the W-2-V EM 204 using a web crawler and a GloVe word embedding neural network coded in Python programming language The web crawler gathers and parses websites and articles as a corpus of text documents that includes thorough explanations and comparisons of various method options in computation pipelines. Then, the W-2-V EM 204 may input this corpus into the GloVe embedding network which may incorporate the method options as dense vectors of a specific length. The embedded vectors should be informative to quantify the similarity and dissimilarity among method options within each step in different pipelines. Additionally, to generate the vector representation of each pipeline, the W-2-V EM 204 can concatenate the vectors of corresponding method options with the same order as they occur in the pipeline (e.g., a 16×3=48-dimensional vector for one example pipeline structure with 3 sub-steps and length 16 each method option). Therefore, the W-2-V EM 204 may generate a q-dimensional representation vector xₚ_{ⱼ}ϵ [symbol] ^{q} for each pipeline pⱼϵ [symbol] .

The autoencoder (AE) is a neural network that concentrates on approximating the input by learning informative features through multiple non-linear layers with structurally symmetric encoder and decoder networks. The variational AE (VAE), including each of the VAEs 206a, 206b, is a deep generative model for learning complex distributions. Similar to classical AEs, each of the VAEs 206a, 206b includes encoder and decoder networks. The encoder maps the inputs into the latent-space representation and the decoder reconstructs the original input from the learned latent features. However, VAEs, including each of the VAEs 206a, 206b, are different from classical AEs in that they encode the input as a distribution which is mapped into the latent-space rather than a single point. This maintenance of data distribution and choice of probabilistic representation provided by the visualization latent-space generator 126 via the VAEs 206a, 206b can help the joint VAE-NCF network 124 to learn more robust latent features by forcing smoother latent-space representations.

To achieve this probabilistic representation, the visualization latent-space generator 126 utilizes the Kullback-Leibler (KL) divergence distance measure to minimize the distance of posterior distribution and the distribution of latent neurons. Therefore, the objective function of the joint VAE-NCF network 124 can be defined by the LNR system 200 as Equation (1) below.

$${min}_{ϕ , θ} \vert \vert x - {p}_{θ} ( {q}_{ϕ} ( z \vert x ) ) {\vert \vert}^{2} + {D}_{K L} ( {μ}_{z} , {σ}_{z} \vert \vert {π}_{z} ) , \qquad ( 1 )$$

where q_{ϕ} (z|x) refers to the encoding distribution of conditional latent z|x for generating latent features z based on the given input x; and p_{θ}(x|z) refers to the decoding distribution reconstructing input condition of the latent features, i.e., x|z. In this objective function, the first term considers the reconstruction error of the original data with p_{θ}(q_{ϕ}(z|x)) referring to the reconstructed input; the second term considers the minimization of KL divergence between the learned distribution and the latent distribution. In the second term, μz and σz corresponds to the learned distribution of latent features which by the second KL divergence term will lead to the prior distribution of latent denoted as π_{z}. In VAEs, including each of the VAEs 206a, 206b, the latent vector with given size v is pre-defined with the prior multivariate Gaussian distribution such as [symbol] (0, 1ᵤ).

In this example, for any dataset dϵ [symbol] and pipeline pϵ [symbol] , the meta-data vector dataset x_{d}ϵ [symbol] ^{t} and the embedded vector of pipeline xₚϵ [symbol] ^{q} are taken as inputs of VAE-Net_{dataset} and VAE-Netₚᵢₚₑₗᵢₙₑ, respectively, Then the hd d^{l} and xₚ^{l} may be exported as outputs of the VAEs 206a, 206b in the l-th layer. The weight matrix, bias vector, and activation function of the l-th layer in the VAE-Net_{dataset} (VAE-Netₚᵢₚₑₗᵢₙₑ) may be defined by W_{d}^{l} (Wₚ^{l}); b_{d}^{l} (bₚ^{l}); and f_{d}^{l} (fₚ^{l}), respectively. Based on these definitions, the LNR system 200 can define Equation set (2) below, which shows the layer-wise process of VAE-Net_{dataset}. The LNR system 200 can perform the same process for VAE-Netₚᵢₚₑₗᵢₙₑ.

$${x}_{d}^{1} = {f}_{d}^{1} ( {W}_{d}^{1} {x}_{d} + {b}_{d}^{1} ) , \qquad ( 2 )$$

$${x}_{d}^{2} = {f}_{d}^{2} ( {W}_{d}^{2} {x}_{d}^{1} + {b}_{d}^{2} ) ,$$

$${z}_{d} = {f}_{d}^{\frac{{L}_{1}}{2}} ( {w}_{d}^{\frac{{L}_{1}}{2}} {x}_{d}^{\frac{{L}_{1}}{2}} + {b}_{d}^{\frac{{L}_{1}}{2}} ) ,$$

$${\hat{x}}_{d} = {f}_{d}^{\frac{{L}_{1}}{2}} ( {w}_{d}^{{L}_{1}} {x}_{d}^{{L}_{1} - 1} + {b}_{d}^{{L}_{1}} ) ,$$

where z_{d} refers to the visualization latent-space representation of the dataset dϵ [symbol] which is equivalent to output of the middle layer due to the VAE's symmetric encoder-decoder structure, i.e.,

$${z}_{d} = {x}_{d}^{\frac{{L}_{1}}{2}}$$

in the VAEs 206a, 206b with L1 layers in total. Also, the reconstructed input of datasets can be found from output of the final layer in the VAEs 206a, 206b, i.e., \hat{x}_{d}=x_{d}^{L}^{₁}. In this example, the VAEs 206a, 206b can use LeakyReLU as the activation function of the first and last layers (i.e., f_{d}¹ and f_{d}^{L}^{₁} and ReLU as the activation function of other layers as they both can effectively deal with the vanishing gradient problem. Classical ReLU encounters a “dying ReLU” problem due to the zero slope for negative inputs, therefore, the LeakyReLU may be used for the first and last layers since the input of the VAEs 206a, 206b, i.e., meta-data vector or pipeline embedded vector, may have positive or negative values and LeakyReLU can support negative values by considering a small non-zero slope for the negative inputs.

A dataset-pipeline interaction can refer to a pipeline's performance on a dataset (e.g., cross-validated error or accuracy of a supervised learning pipeline on a dataset). To model dataset-pipeline interactions, the dataset-pipeline interaction model 128 can utilize traditional latent factor methods (LFM) such as matrix factorization (MF), variational Bayesian matrix factorization (VMF), or factorization machine (FM) which are only based on linear kernels (e.g., inner product of the dataset's and pipeline's latent factors). However, LFMs may not be able to capture dataset-pipeline relations with complex non-linear structures. Therefore, deep learning (DL)-based recommendation models, such as collaborative denoising autoencoder (CDAE), deep factorization machine (DFM), and neural collaborative filtering (NCF), may be used to overcome shortcomings of the conventional approaches. Among different DL-based approaches, in the example shown in FIG. 2, the dataset-pipeline interaction model 128 may use NCF since it can effectively and efficiently capture non-linear and non-trivial dataset-pipeline relationships by simultaneously considering (1) the generalized non-linear matrix factorization (GMF) of the recommendation response by the GMF component 208 and (2) the multi-layer projection (MLP) of the dataset's and pipeline's characteristics by the MLP component 210.

Therefore, the visualization latent-space features of datasets and pipelines can be imported to the dataset-pipeline interaction model 128 to predict the dataset-pipeline interactions. In the dataset-pipeline interaction model 128, three main sub-steps may be implemented. In the first sub-step, the dataset-pipeline interaction model 128 can use GMF to calculate the Hadamard product of the dataset and pipeline latent factors, which can be defined by the LNR system 200 as Equation (3) below. In the second sub-step, the dataset-pipeline interaction model 128 can apply MLP to the concatenated datasets' and pipelines' latent vectors in a collaborative filtering module, which can be defined by the LNR system 200 as Equation (4) below. In the final sub-step, the dataset-pipeline interaction model 128 can concatenate and project outputs of the previous two steps with a non-linear activation function to predict the high-level dataset-pipeline relations. In this example, the LNR system 200 can define Equation (5) below to represent the final step of this interaction modeling.

$${Φ}^{GMF} = {z}_{d} ⊙ {z}_{p} \qquad ( 3 )$$

$${Φ}^{MLP} = {f}_{dp}^{{L}_{2}} ( {W}_{dp}^{{L}_{2}} ( {f}_{dp}^{{L}_{2} - 1} ( … {f}_{dp}^{1} ( {W}_{dp}^{1} [ \begin{matrix}{Z}_{d} \\ {Z}_{p}\end{matrix} ] + {b}_{dp}^{1} ) … ) ) + {b}_{dp}^{{L}_{2}} ) , \qquad ( 4 )$$

$${\hat{y}}_{dp} = \frac{1}{1 + exp} ( - {h}^{T} [ \begin{matrix}{Φ}^{GMF} \\ {Φ}^{MNP}\end{matrix} ] ) / T ) \qquad ( 5 )$$

where ⊙ refers to the Hadamard product; and Φ^{GMF} and Φ^{MLP} represent outputs of the GMF component 208 and the MLP component 210, respectively. For any dataset dϵ [symbol] and pipeline pϵ [symbol] , the z_{d} and zₚ denote the visualization latent features. Also, the weight matrix, bias vector, and activation function of the l-th layer in the NCF network will be denoted by W_{dp}¹, b_{dp}¹ and f_{dp}¹, respectively. The non-linear activation function of the last prediction layer is sigmoid with the temperature value T which controls the diversity of predictions. The h vector refers to weights of the final prediction layer; and theŷ_{dp} represents the predicted dataset-pipeline interaction, i.e., predicted performance of pipeline p on the dataset d. Since we previously explained that these interactions are the cross-validated accuracy of each pipeline on each dataset, we use the sigmoid activation function to smoothly enforce the predicted interaction being between zero and one.

In the example shown in FIG. 2, the LNR system 200 methodology includes two main steps. First, the generation of datasets' and pipelines' visualization latent-space features by the visualization latent-space generator 126 via the VAEs 206a, 206b. Second, the prediction of complex dataset-pipeline interactions (i.e., pipeline's performance on a dataset) by the dataset-pipeline interaction model 128 via the GMF component 208 and the MLP component 210. The former step contains two parallel VAE-based neural networks, one network for latent generation of datasets datasets (VAE-Net_{dataset}), and another network for the latent generation of pipelines (VAE-Netₚᵢₚₑₗᵢₙₑ). Then, output of the former step can be imported as the input into the next step in which the dataset-pipeline interaction model 128 (e.g., a neural network) is used to model the intricate and nonlinear dataset-pipeline relations. These two steps of deep feature extraction and deep dataset-pipeline interaction modeling are coupled tightly in the LNR system 200, which can be optimized jointly in an end-to-end training manner. A hybrid loss function that may be defined and/or implemented by the LNR system 200 to train the joint VAE-NCF network 124 is defined in Equation (6).

[symbol]

= [symbol] _{R}+λ₁( [symbol] _{D}+ [symbol] _{P})+λ₂ [symbol] _{S} ,(6)

where hybrid loss (i.e., [symbol] ) consists of three main objectives: (1) the dataset-pipeline relation prediction (denoted as [symbol] _{R}); (2) the distribution latent representation learning of datasets and pipelines (denoted as [symbol] _{D} and [symbol] _{P}, respectively); and (3) the continuity and smoothness manager of the visualization profile (denoted as [symbol] _{S}). The objective of this combination is to consider two main steps of the LNR system 200 which are the generation of datasets' and pipelines' visualization representations and the prediction of dataset-pipeline interaction score. In Equation (6), the λ₁, and λ₂ denote the hyperparameters of the loss function that may be tuned by the LNR system 200 to balance recommendation, reconstruction, and smoothness objectives in the visualization profile. To find the best balance of these two tuning hyperparameters, the LNR system 200 may apply the two-level 5-fold cross validation-based grid search in this example.

To consider the interaction prediction in the optimization of this problem, the LNR system 200 can apply the log loss function which can integrate both implicit and explicit feedback of each pipeline's performance on each dataset. Therefore, the loss function of NCF section for the dataset-pipeline interaction learning can be defined by the LNR system 200 as Equation (7) below.

$${ℒ}_{R} = {\sum }_{d ∈ 𝔻} {\sum }_{p ∈ ℙ} {r}_{dp} log {\hat{y}}_{dp} + ( 1 - {r}_{dp} ) log ( 1 - {\hat{y}}_{dp} ) \qquad ( 7 )$$

where

$${r}_{dp} = \frac{{y}_{dp}}{max ( {y}_{d} )} and {y}_{d} = [ {y}_{d , p 1 , … , {y}_{d , pn}} ]$$

refers to the vector of all the existing cross-validated performance of pipelines on the dataset d. Also, ŷ_{dp} represents the predicted performance of pipeline p on the dataset d. This objective function is similar to the binary cross entropy loss with label smoothing to consider the impact of explicit feedback as well as the implicit feedback on the loss function.

To maintain distribution of datasets and pipelines in the learned representation space, the visualization latent-space generator 126 can use two parallel VAE networks such as, for instance, the VAEs 206a, 206b. The VAEs 206a, 206b can be embodied and implemented as structurally symmetrical VAEs. The loss function of VAE for datasets' and pipelines' probabilistic latent representation learning can be defined by the LNR system 200 as Equations (8) and (9) below.

$${ℒ}_{D} = {\sum }_{i = 1}^{m} {‖ {x}_{{d}_{i}} - {p}_{θ}^{( 1 )} ( {q}_{Φ}^{( 1 )} ( {z}_{{d}_{i}} \vert {x}_{{d}_{i}} ) ) ‖}^{2} + {D}_{KL} ( {μ}_{{z}_{{d}_{i}}} , {σ}_{{z}_{{d}_{i}}} ‖ 𝒩 ( 0 , 1 ) ) \qquad ( 8 )$$

$${ℒ}_{P} = {\sum }_{j = 1}^{m} {‖ {x}_{pj} - {p}_{θ}^{( 2 )} ( {q}_{Φ}^{( 2 )} ( {z}_{{p}_{j}} \vert {x}_{{p}_{j}} ) ) ‖}^{2} + {D}_{KL} ( {μ}_{{z}_{{p}_{j}}} , {σ}_{{z}_{{p}_{j}}} ‖ 𝒩 ( 0 , 1 ) ) \qquad ( 9 )$$

where in both [symbol] _{D} and [symbol] _{P}, the first term refers to the reconstruction error of the original data in which the q_{ϕ}⁽¹⁾ (z|x) (or q_{ϕ}⁽²⁾ (z|x)) refers to the encoding process to calculate probability of latent factor z given the input x and the p_{θ}⁽¹⁾ (x|z) (or p_{θ}⁽²⁾ (x|z)) refers to the decoding process of reconstructing input x from latent vector z in the VAE-Net_{dataset} (or VAE-Netₚᵢₚₑₗᵢₙₑ). The second term in both equations refers to the KL divergence between the learned distribution and the distribution of latent-space, where

$${μ}_{{z}_{{d}_{i}}} ( or {μ}_{{z}_{{p}_{j}}} ) and {σ}_{{z}_{{d}_{i}}} ( or {σ}_{{z}_{{p}_{j}}} )$$

represent the mean and variance of the learned distribution for VAE-Net_{dataset} (or VAE-Netₚᵢₚₑₗᵢₙₑ).

In a visualization profile of an example visual representation described herein, the LNR system 200 can generate the latitude and longitude based on latent variable space of VAEs that can be learned and described (e.g., created) by the visualization latent-space generator 126 via the VAEs 206a, 206b. The LNR system 200 can further generate the altitudes in such a visualization profile based on dataset-pipeline interactions that can be predicted by the dataset-pipeline interaction model 128 via the GMF component 208 and the MLP component 210. To combine all this information in a map that can effectively capture similarities and provide the informative visualization, the LNR system 200 can take into consideration the continuity and smoothness of such a visualization profile. The preservation of distribution in the latent-space provided by VAE (e.g., the VAEs 206a, 206b) can lead to the joint VAE-NCF network 124 toward learning smoother representations. To further lead the joint VAE-NCF network 124 toward learning smoother representations, in some cases the LNR system 200 may further account for the smoothness of the altitude. To achieve this, the LNR system 200 can ensure the continuity and smoothness of the visualization profile by adding the Lipschitz continuity constraint to the optimization problem that can be defined and implemented by the LNR system 200 as described herein. A function is locally K-Lipschitz continuous if ∥∇f(x)∥₂≤K for some constant K. Therefore, the LNR system 200 can define the following one-sided gradient penalties in the loss function to turn the hard Lipschitz continuity constraint into the soft one. For instance, the LNR system 200 can consider the regularization term similar to the squared Hinge loss to consider this constraint as the one-sided penalty which considers greater penalties for ∥∇f(x)∥₂>1 compared to when ∥∇f(x)∥₂<1. The LNR system 200 can define Equation (10) below to represent the integration of these one-sided penalties for the 1-Lipschitz continuity constraint in the visualization profiles of both datasets' and pipelines' worlds.

[symbol]

=Σᵢ₌₁ⁿ^{ᵢ} (max {0, ∥∇f(z_{d}_{ᵢ})∥₂−1})²+Σⱼ₌₁ⁿ (max {0, ∥∇f(zₚ_{ⱼ})∥₂−1})² ,(10)

where

$$∇ f ( {z}_{d} ) = [ \frac{{\hat{y}}_{d}}{{z}_{d}^{1}} , … , \frac{{\hat{y}}_{d}}{{z}_{d}^{s}} ] and ∇ f ( {z}_{p} ) = [ \frac{{\hat{y}}_{p}}{{z}_{p}^{1}} , … , \frac{{\hat{y}}_{p}}{{z}_{p}^{s}} ]$$

refer to the gradient of final predicted interaction score with respect to the v-dimensional visualization latent factors of dataset d and pipeline p, respectively.

All the above-described approaches can help the LNR system 200 to define an interactive bridge between two visualization worlds denoted as (1) world of pipelines and (2) world of datasets. To generate the visualization for world map of pipelines, the LNR system 200 can follow four main steps in one example: (1) constructing 2D meshgrids in 2D latent-space of pipelines generated by the VAE Netₚᵢₚₑₗᵢₙₑ (e.g., the VAE 206b), (2) finding 3D a predicted visualization profile for each grid cell in the meshgrid of pipelines, (3) rearranging colormaps corresponding to different pipelines in the meshgrid cells, and (4) projecting the resulting grid world of pipelines to a sphere space to represent the world map analogy for the world map of AI as a 3D sphere visualization in this example.

The LNR system 200 can also perform this same procedure or a similar version thereof for the 2D meshgrid in the latent-space of datasets. By implementing this approach, the LNR system 200 can locate all the 3D colormaps like pieces of puzzles in the meshgrids which can help the LNR system 200 and/or users of the system to develop a 4D interactive visualization platform between the world of pipelines and the world of datasets. Then, as noted above, in some cases the LNR system 200 can also project these grid world of pipelines and datasets to a sphere space to better represent the world map analogy for the world map of AI.

FIG. 3A illustrates an example visual representation 300a of learned computation pipeline-dataset relationships and predicted pipeline-dataset interactions according to at least one embodiment of the present disclosure. FIG. 3B illustrates three side views of another example visual representation 300b of learned computation pipeline-dataset relationships and predicted pipeline-dataset interactions according to at least one embodiment of the present disclosure. The visual representations 300a, 300b can be generated by at least one of the computing device 102 or the remote computing devices 104 using the LNR system 120 or the LNR system 200, respectively, according to one or more examples described herein.

As illustrated in FIG. 3A, the computing device 102 can generate the visual representation 300a as a 2D grid such as, for instance, a 2D meshgrid having a plurality of 2D meshgrid cells that respectively correspond to and represent a certain pipeline-dataset pairing. The computing device 102 can generate each meshgrid cell such that it illustrates learned latent visualization pipeline-dataset relationships (e.g., interactive clustering patterns, covariates) for a particular pipeline-dataset paring as latitude data (e.g., vertically along the cell) and longitude data (e.g., horizontally along the cell). The computing device 102 can further use such learned relationships to generate each meshgrid cell such that it illustrates predicted pipeline-dataset interactions (e.g., pipeline-dataset performance data) for such a particular pipeline-dataset paring as altitude data (e.g., extending from the cell).

In the example shown, the computing device 102 can generate each meshgrid cell as a colormap (or “heatmap”) representing such learned latent visualization pipeline-dataset relationships and predicted pipeline-dataset interactions for a particular pipeline-dataset pairing. In this example, the computing device 102 may arrange such individual colormaps (i.e., meshgrid cells) as described herein to generate a collective colormap that visualizes all learned latent visualization pipeline-dataset relationships and predicted pipeline-dataset interactions for all pipeline-dataset pairings evaluated, as illustrated by the visual representation 300a in FIG. 3A. The computing device 102 may arrange such individual colormaps (i.e., meshgrid cells) to generate a collective colormap that can visualize such learned relationships and predicted interactions in an informative and perceivable manner, for a particular purpose or application.

In some examples, the computing device 102 can generate the visual representation 300a such that it presents informative and perceivable data that may be used to evaluate one or more computation pipelines independently or against one another with respect to one or more datasets. In one example, the computing device 102 can generate the visual representation 300a such that it visualizes performance of one or more randomly chosen pipelines over one or more datasets. In another example, the computing device 102 can generate the visual representation 300a such that it visualizes a group of the relatively best performing pipelines across all datasets. In this example, circle 302 in FIG. 3A can correspond to regions of AI methods that perform relatively better with respect to one or more datasets.

In other examples, the computing device 102 can generate the visual representation 300a such that it presents informative and perceivable data that are useful for evaluating one or more datasets against one another with respect to one or more computation pipelines. In one example, the computing device 102 can generate the visual representation 300a such that it visualizes performance of all pipelines on a randomly chosen dataset. In another example, the computing device 102 can generate the visual representation 300a such that it visualizes a group of the relatively best performing datasets across all pipelines. In this example, the circle 302 in FIG. 3A can correspond to dataset regions (e.g., scope) that are relatively more suitable for all AI methods evaluated.

To generate the visual representation 300a, the computing device 102 can use learned latent visualization pipeline-dataset relationships and predicted pipeline-dataset performance data that can be learned and predicted, respectively, by either or both of the LNR systems 120, 200 (e.g., via the joint VAE-NCF network 124) as described above with refence to FIGS. 1 and 2. In one example, the computing device 102 can construct a 2D meshgrid of different datasets or different computation pipelines in the aforementioned first 2D latent space or second 2D latent space, respectively. In this example, the computing device 102 can further determine a 3D predicted visualization profile for each meshgrid cell in the 2D meshgrid and generate a colormap for each meshgrid cell of the 2D meshgrid based on the 3D predicted visualization profile, the colormap being indicative of predicted performance data of one of the computation pipelines with respect to one of the datasets. In this example, the computing device 102 can then arrange meshgrid cells in the 2D meshgrid based at least one of the relationships or the performance data, where subsets of the meshgrid cells that have at least one of similar relationships or similar performance data are arranged adjacent to one another. In this example, to generate the visual representation 300b illustrated in FIG. 3B, the computing device 102 can further project the 2D meshgrid to a 3D space, to form the visual representation 300b as a sphere-shaped visual representation of the relationships and the performance data.

In another example, to generate the visual representation 300a, the computing device 102 can decompose the latent variable space of pipelines and datasets to a 32×32 (in total 1,024) meshgrid cells, or other suitable number of meshgrid cells, where each cell refers to one pipeline candidate, and one dataset candidate, respectively. Then, the computing device 102 can use the joint VAE-NCF network 124 to find the colormap for the 3D predicted performance profile of each pipeline cell over all datasets, and each dataset cell over all pipelines. In other words, each meshgrid cell of the visual representation 300a shows the 3D profile for the predicted performance of the pipeline over all the 1,024 dataset cells in the meshgrid of dataset latent variable space. In some cases, each meshgrid cell of the visual representation 300a can represent the 3D profile for the predicted performance of all the 1,024 pipeline cells in the meshgrid of pipelines on each selected dataset cell. In the example shown, all the meshgrid cells have the 3D profiles represented by 2D colormaps in which the third dimension (e.g., the altitude of the performance profile) is depicted by distinct colors, with certain colors denoting peaks and other colors denoting valleys of the performance profile. Then, the computing device 102 in this example can project these meshgrid worlds of pipelines and datasets to the sphere space to form the visual representation 300b as a sphere-shaped visual representation of the relationships and the performance data.

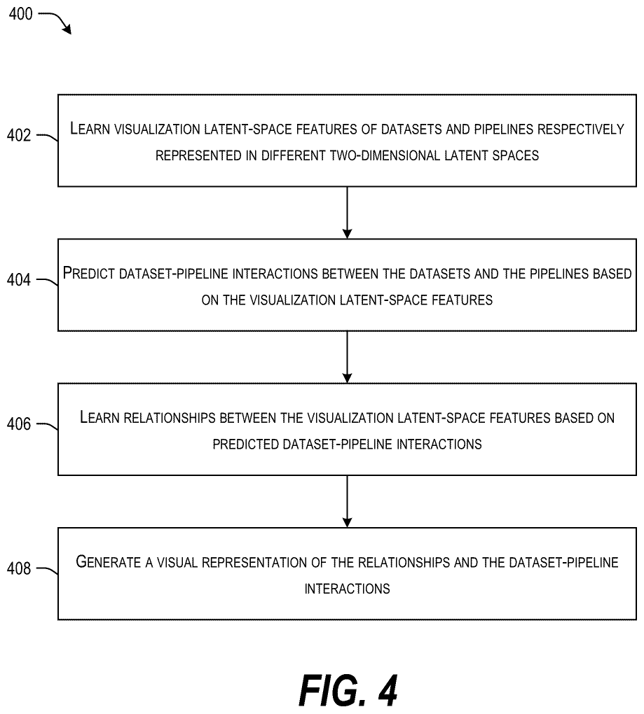

FIG. 4 illustrates a flow diagram of an example computer-implemented method 400 that can facilitate visualization of computation pipeline and dataset exploration according to at least one embodiment of the present disclosure. In one example, computer-implemented method 400 (or “the method 400”) can be implemented by the computing device 102, or by one or more of the remote computing devices 104 in some cases. The method 400 can be implemented in the context of the environment 100 or another environment using one or more of the LNR system 120 or the LNR system 200.

At 402, the method 400 includes learning visualization latent-space features of datasets and computation pipelines that are respectively represented in different 2D latent spaces. For instance, the computing device 102 (e.g., via the LNR system 120) can learn dataset visualization latent-space features of different datasets represented in a first 2D latent space and pipeline visualization latent-space features of different computation pipelines represented in a second 2D latent space as described above with reference to FIGS. 1 and 2.

At 404, the method 400 further includes predicting (e.g., via modeling) dataset-pipeline interactions between the datasets and the computation pipelines based on the visualization latent-space features. For example, the computing device 102 can model (e.g., predict) dataset-pipeline interactions between different datasets and different computation pipelines based on dataset visualization latent-space features of the different datasets and pipeline visualization latent-space features of the different computation pipelines as described above with reference to FIGS. 1 and 2.

At 406, the method 400 further includes learning relationships between the visualization latent-space features based on predicted dataset-pipeline interactions. For example, the computing device 102 can learn relationships between dataset visualization latent-space features and pipeline visualization latent-space features by predicting dataset-pipeline interactions using such features as described above with reference to FIGS. 1 and 2.

At 408, the method 400 further includes generating a visual representation of the relationships and the dataset-pipeline interactions. For example, the computing device 102 can generate one or both of the visual representations 300a, 300b as described above with reference to FIGS. 1, 2, 3A, and 3B.

Referring now to FIG. 1, an executable program can be stored in any portion or component of the memory 114. The memory 114 can be embodied as, for example, a random access memory (RAM), read-only memory (ROM), magnetic or other hard disk drive, solid-state, semiconductor, universal serial bus (USB) flash drive, memory card, optical disc (e.g., compact disc (CD) or digital versatile disc (DVD)), floppy disk, magnetic tape, or other types of memory devices.

In various embodiments, the memory 114 can include both volatile and nonvolatile memory and data storage components. Volatile components are those that do not retain data values upon loss of power. Nonvolatile components are those that retain data upon a loss of power. Thus, the memory 114 can include, for example, a RAM, ROM, magnetic or other hard disk drive, solid-state, semiconductor, or similar drive, USB flash drive, memory card accessed via a memory card reader, floppy disk accessed via an associated floppy disk drive, optical disc accessed via an optical disc drive, magnetic tape accessed via an appropriate tape drive, and/or other memory component, or any combination thereof. In addition, the RAM can include, for example, a static random-access memory (SRAM), dynamic random-access memory (DRAM), or magnetic random-access memory (MRAM), and/or other similar memory device. The ROM can include, for example, a programmable read-only memory (PROM), erasable programmable read-only memory (EPROM), electrically erasable programmable read-only memory (EEPROM), or other similar memory devices.

As discussed above, the LNR system 120, the covariates generation machine 122, the joint VAE-NCF network 124, the visualization latent-space generator 126, the dataset-pipeline interaction model 128, the computation pipeline module 130, the recommender module 132, and the communications stack 134 can each be embodied, at least in part, by software or executable-code components for execution by general purpose hardware. Alternatively, the same can be embodied in dedicated hardware or a combination of software, general, specific, and/or dedicated purpose hardware. If embodied in such hardware, each can be implemented as a circuit or state machine, for example, that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components.

Referring now to FIG. 4, the flowchart or process diagram shown in FIG. 4 is representative of certain processes, functionality, and operations of the embodiments discussed herein. Each block can represent one or a combination of steps or executions in a process. Alternatively, or additionally, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as the processor 112. The machine code can be converted from the source code. Further, each block can represent, or be connected with, a circuit or a number of interconnected circuits to implement a certain logical function or process step.

Although the flowchart or process diagram shown in FIG. 4 illustrates a specific order, it is understood that the order can differ from that which is depicted. For example, an order of execution of two or more blocks can be scrambled relative to the order shown. Also, two or more blocks shown in succession can be executed concurrently or with partial concurrence. Further, in some embodiments, one or more of the blocks can be skipped or omitted. In addition, any number of counters, state variables, warning semaphores, or messages might be added to the logical flow described herein, for purposes of enhanced utility, accounting, performance measurement, or providing troubleshooting aids. Such variations, as understood for implementing the process consistent with the concepts described herein, are within the scope of the embodiments.

Also, any logic or application described herein, including the LNR system 120, the covariates generation machine 122, the joint VAE-NCF network 124, the visualization latent-space generator 126, the dataset-pipeline interaction model 128, the computation pipeline module 130, the recommender module 132, and the communications stack 134 can be embodied, at least in part, by software or executable-code components, can be embodied or stored in any tangible or non-transitory computer-readable medium or device for execution by an instruction execution system such as a general-purpose processor. In this sense, the logic can be embodied as, for example, software or executable-code components that can be fetched from the computer-readable medium and executed by the instruction execution system. Thus, the instruction execution system can be directed by execution of the instructions to perform certain processes such as those illustrated in FIG. 4. In the context of the present disclosure, a non-transitory computer-readable medium can be any tangible medium that can contain, store, or maintain any logic, application, software, or executable-code component described herein for use by or in connection with an instruction execution system.

The computer-readable medium can include any physical media such as, for example, magnetic, optical, or semiconductor media. More specific examples of suitable computer-readable media include, but are not limited to, magnetic tapes, magnetic floppy diskettes, magnetic hard drives, memory cards, solid-state drives, USB flash drives, or optical discs. Also, the computer-readable medium can include a RAM including, for example, an SRAM, DRAM, or MRAM. In addition, the computer-readable medium can include a ROM, a PROM, an EPROM, an EEPROM, or other similar memory device.

Disjunctive language, such as the phrase “at least one of X, Y, or Z,” unless specifically stated otherwise, is to be understood with the context as used in general to present that an item, term, or the like, can be either X, Y, or Z, or any combination thereof (e.g., X, Y, and/or Z). Thus, such disjunctive language is not generally intended to, and should not, imply that certain embodiments require at least one of X, at least one of Y, or at least one of Z to be each present. As referenced herein in the context of quantity, the terms “a” or “an” are intended to mean “at least one” and are not intended to imply “one and only one.”

As referred to herein, the terms “includes” and “including” are intended to be inclusive in a manner similar to the term “comprising.” As referenced herein, the terms “or” and “and/or” are generally intended to be inclusive, that is (i.e.), “A or B” or “A and/or B” are each intended to mean “A or B or both.” As referred to herein, the terms “first,” “second,” “third,” and so on, can be used interchangeably to distinguish one component or entity from another and are not intended to signify location, functionality, or importance of the individual components or entities. As referenced herein, the terms “couple,” “couples,” “coupled,” and/or “coupling” refer to chemical coupling (e.g., chemical bonding), communicative coupling, electrical and/or electromagnetic coupling (e.g., capacitive coupling, inductive coupling, direct and/or connected coupling), mechanical coupling, operative coupling, optical coupling, and/or physical coupling.

It should be emphasized that the above-described embodiments of the present disclosure are merely possible examples of implementations set forth for a clear understanding of the principles of the disclosure. Many variations and modifications can be made to the above-described embodiment(s) without departing substantially from the spirit and principles of the disclosure. All such modifications and variations are intended to be included herein within the scope of this disclosure and protected by the following claims.

Therefore, at least the following is claimed:

1. A method to analyze computation pipelines and datasets, the method comprising:
learning, by at least one computing device, first visualization latent-space features of different datasets represented in a first two-dimensional latent space and second visualization latent-space features of different computation pipelines represented in a second two-dimensional latent space;
modeling, by the at least one computing device, dataset-pipeline interactions between the different datasets and the different computation pipelines based on the first visualization latent-space features and the second visualization latent-space features; and
learning, by the at least one computing device, relationships between the first visualization latent-space features and the second visualization latent-space features based on modeling the dataset-pipeline interactions.

2. The method of claim 1, wherein learning the first visualization latent-space features and the second visualization latent-space features comprises:
implementing, by the at least one computing device, two structurally symmetric variational autoencoders in parallel to respectively learn the first visualization latent-space features in the first two-dimensional latent space and the second visualization latent-space features in the second two-dimensional latent space.

3. The method of claim 1, wherein modeling the dataset-pipeline interactions comprises:
implementing, by the at least one computing device, a neural collaborative filtering network to predict performance metrics of the different computation pipelines with respect to the different datasets based on the first visualization latent-space features and the second visualization latent-space features.

4. The method of claim 1, wherein modeling the dataset-pipeline interactions comprises:
implementing, by the at least one computing device, a neural collaborative filtering network to model the dataset-pipeline interactions using a neural collaborative filtering process comprising generalized matrix factorization of a recommendation matrix generated by the neural collaborative filtering network and multi-layer projection of the first visualization latent-space features and the second visualization latent-space features.

5. The method of claim 1, further comprising:
generating, by the at least one computing device, a visual representation of the relationships and the dataset-pipeline interactions, the visual representation comprising:
latitude and longitude data that are indicative of the relationships; and
altitude data that are indicative of the dataset-pipeline interactions.

6. The method of claim 1, further comprising:
generating, by the at least one computing device, meta-data vectors respectively corresponding to the different datasets, the meta-data vectors being generated based on respective summary statistics data of the different datasets; and
generating, by the at least one computing device, embedding vectors respectively corresponding to the different computation pipelines based on data indicative of different pipeline component candidates of the different computation pipelines.

7. The method of claim 1, further comprising:
generating, by the at least one computing device using a first of two structurally symmetric variational autoencoders, first visualization latent-space representations of the different datasets in the first two-dimensional latent space based on meta-data vectors respectively corresponding to the different datasets; and
generating, by the at least one computing device using a second of the two structurally symmetric variational autoencoders, second visualization latent-space representations of the different computation pipelines in the second two-dimensional latent space based on embedding vectors respectively corresponding to the different computation pipelines.

8. The method of claim 1, further comprising:
learning, by the at least one computing device using a first of two structurally symmetric variational autoencoders, the first visualization latent-space features in the first two-dimensional latent space based on first visualization latent-space representations that correspond to and represent the different datasets in the first two-dimensional latent space; and
learning, by the at least one computing device using a second of the two structurally symmetric variational autoencoders, the second visualization latent-space features in the second two-dimensional latent space based on second visualization latent-space representations that correspond to and represent the different computation pipelines in the second two-dimensional latent space.

9. The method of claim 1, further comprising:
training, by the at least one computing device, a joint variational autoencoder neural collaborative filtering network to learn the relationships using a hybrid loss function that drives the joint variational autoencoder neural collaborative filtering network toward achieving at least one of:
a defined cluster-wised ranking prediction accuracy;
a defined visualization latent-space representation generation accuracy in the first two-dimensional latent space and the second two-dimensional latent space; or
a defined visualization profile continuity and smoothness of a visual representation of the relationships and the dataset-pipeline interactions.

10. A computing device, comprising:
a memory device to store computer-readable instructions thereon; and
at least one processing device configured through execution of the computer-readable instructions to:
learn first visualization latent-space features of different datasets represented in a first two-dimensional latent space and second visualization latent-space features of different computation pipelines represented in a second two-dimensional latent space;
model dataset-pipeline interactions between the different datasets and the different computation pipelines based on the first visualization latent-space features and the second visualization latent-space features; and
learn relationships between the first visualization latent-space features and the second visualization latent-space features based on modeling the dataset-pipeline interactions.

11. The computing device of claim 10, wherein, to learn the first visualization latent-space features and the second visualization latent-space features, the at least one processing device is further configured to:
implement two structurally symmetric variational autoencoders in parallel to respectively learn the first visualization latent-space features in the first two-dimensional latent space and the second visualization latent-space features in the second two-dimensional latent space.

12. The computing device of claim 10, wherein, to model the dataset-pipeline interactions, the at least one processing device is further configured to:
implement a neural collaborative filtering network to predict performance metrics of the different computation pipelines with respect to the different datasets based on the first visualization latent-space features and the second visualization latent-space features.

13. The computing device of claim 10, wherein, to model the dataset-pipeline interactions, the at least one processing device is further configured to:
implement a neural collaborative filtering network to model the dataset-pipeline interactions using a neural collaborative filtering process comprising generalized matrix factorization of a recommendation matrix generated by the neural collaborative filtering network and multi-layer projection of the first visualization latent-space features and the second visualization latent-space features.

14. The computing device of claim 10, wherein the at least one processing device is further configured to:
generate a visual representation of the relationships and the dataset-pipeline interactions, the visual representation comprising:
latitude and longitude data that are indicative of the relationships; and
altitude data that are indicative of the dataset-pipeline interactions.

15. The computing device of claim 10, wherein the at least one processing device is further configured to:
train a joint variational autoencoder neural collaborative filtering network to learn the relationships using a hybrid loss function that drives the joint variational autoencoder neural collaborative filtering network toward achieving at least one of:
a defined cluster-wised ranking prediction accuracy;
a defined visualization latent-space representation generation accuracy in the first two-dimensional latent space and the second two-dimensional latent space; or
a defined visualization profile continuity and smoothness of a visual representation of the relationships and the dataset-pipeline interactions.

16. A method for visualizing computation pipeline and dataset exploration, the method comprising:
learning, by at least one computing device, relationships between first visualization latent-space features of different datasets represented in a first two-dimensional latent space and second visualization latent-space features of different computation pipelines represented in a second two-dimensional latent space;
predicting, by the at least one computing device, performance data of the different computation pipelines with respect to the different datasets based on the relationships; and
generating, by the at least one computing device, a visual representation of the
relationships and the performance data, the visual representation comprising:
latitude and longitude data that are indicative of the relationships; and
altitude data that are indicative of the performance data.

17. The method of claim 16, wherein generating the visual representation comprises:
constructing, by the at least one computing device, a two-dimensional meshgrid of the different datasets or the different computation pipelines in the first two-dimensional latent space or the second two-dimensional latent space, respectively.

18. The method of claim 17, further comprising:
determining, by the at least one computing device, a three-dimensional predicted visualization profile for each meshgrid cell in the two-dimensional meshgrid; and
generating, by the at least one computing device, a colormap for each meshgrid cell of the two-dimensional meshgrid based on the three-dimensional predicted visualization profile, the colormap being indicative of predicted performance data of one of the different computation pipelines with respect to one of the different datasets.

19. The method of claim 18, further comprising:
arranging, by the at least one computing device, meshgrid cells in the two-dimensional meshgrid based at least one of the relationships or the performance data, wherein subsets of the meshgrid cells having at least one of similar relationships or similar performance data are arranged adjacent to one another.

20. The method of claim 19, further comprising:
projecting, by the at least one computing device, the two-dimensional meshgrid to a three-dimensional space; and
generating, by the at least one computing device, a sphere-shaped visual representation of the relationships and the performance data based on projecting the two-dimensional meshgrid to the three-dimensional space.
